(19) United States
(12) Patent Application Publication
(10) Pub. No.: US 2025/0005779 A1
(43) Pub. Date: Jan. 2, 2025

(54) APPARATUS AND METHOD TO DETECT CONCEALED WEAPONS FROM A DISTANCE

(71) Applicant: KONICA MINOLTA BUSINESS SOLUTIONS U.S.A., INC., Foster City, CA (US)

(72) Inventor: Yongmian ZHANG, San Mateo, CA (US)

(21) Appl. No.: 18/217,404

(22) Filed: Jun. 30, 2023

(51) Int. Cl. G06T 7/70; G06T 7/20; G06V 10/24; H04N 23/695; H04N 23/698

(52) U.S. Cl. CPC G06T 7/70; G06T 7/20; G06V 10/24; H04N 23/695; H04N 23/698; G06T 2207/10024; G06V 2201/07

(57) ABSTRACT

Apparatus and method to detect concealed weapons on a person from a distance coordinates movement of a field of view (FOV) of a wide angle view (WAV) camera with movement of an FOV of a millimeter wave (MMW) camera. In an embodiment, the apparatus identifies and tracks a plurality of individuals within the WAV camera FOV. The MMW camera is focused on a first of the identified plurality of individuals, and takes an image of the individual within the MMW camera FOV. In an embodiment, the first individual is centered in the MMW camera FOV. The image is analyzed to detect whether the individual is carrying any concealed weapons. If concealed weapons are detected, the apparatus may signal a need to detain and/or apprehend the individual.

### BACKGROUND OF THE INVENTION

One way of detecting concealed weapons underneath a person's clothing is to install a screening device in controlled stationary access settings such as an airport security gate, a building entrance, or the like. People passing through such a screen device have to empty their pockets and sometimes stand still with open and and/or raised arms.

It would be desirable to be able to detect concealed weapons from a distance, especially when a controlled flow of people through a stationary access setting is not possible. It also would be desirable for people not to be stopped while being screened.

### SUMMARY OF THE INVENTION

Aspects of the present invention provide a concealed weapon detection (CWD) apparatus and method. In an embodiment, the apparatus may comprise: a millimeter wave (MMW) camera; a pan/tilt platform on which the MMW camera is mounted; a wide angle view (WAV) camera; and apparatus to sync a view of the WAV camera with movement of the MMW camera to enable detection, from a distance, of whether one or more of a plurality of individuals in an open area is carrying a concealed weapon.

In an embodiment, the apparatus to sync the MMW and WAV cameras may comprise a multi-target tracking module to guide movement of the WAV camera so that the MMW camera can perform the detection. In an apparatus, the WAV and MMW cameras may be synced using a known camera calibration method, as ordinarily skilled artisans will appreciate.

Embodiments according to the present invention dynamically capture, from a distance, one or more of a plurality of individuals to scan for concealed weapons while the individuals are moving.

Calibration of two heterogeneous sensor types in an automatic fashion during system operation can be challenging. In one aspect, the present invention provides a novel targetless calibration method for automatically mapping a person's location, in an open area, within the field of view of a wide-angle-view camera to the MMW camera to enable concealed weapon detection from a distance.

### BRIEF DESCRIPTION OF THE DRAWINGS

Various aspects of the invention now will be described in detail with reference to exemplary non-limiting embodiments, with reference to the accompanying drawings, in which:

FIGS. 1A and 1B are high level block diagrams of an on-site concealed weapon detection system according to an embodiment, and of interaction between a remote system and the on-site system according to an embodiment;

FIGS. 2A and 2B show images taken with respective sensors in an MMW camera;

FIG. 3 is a high-level diagram of a pan and tilt apparatus according to an embodiment;

FIG. 4 is a representation of images taken by an MMW camera within the WAV camera's field of view according to an embodiment;

FIG. 5 is a pictorial representation of a calibration procedure between the WAV camera and the MMW camera according to an embodiment;

FIG. 6 illustrates a transformation between an MMW image and a WAV image according to an embodiment;

FIGS. 7A and 7B are representations of an individual within a field of view of an MMW camera according to an embodiment;

FIG. 8 is a representation of a target board that may be used with one or more embodiments; and

FIG. 9 is a high-level flow chart depicting overall operation of the concealed weapons detection system according to an embodiment.

### DETAILED DESCRIPTION OF EMBODIMENTS

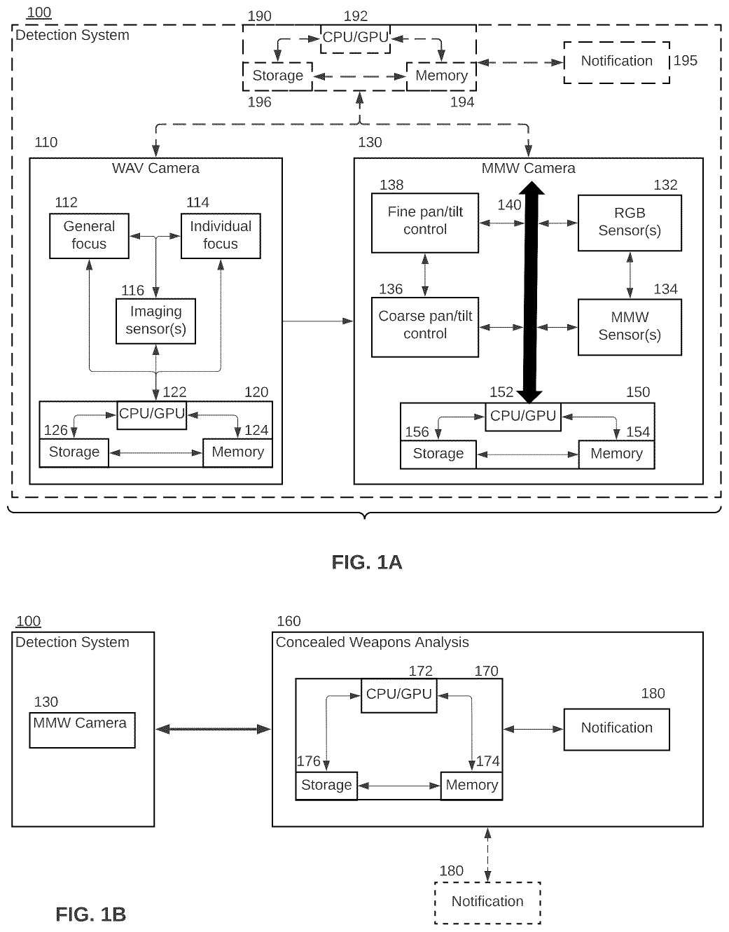

In FIG. 1A, in an embodiment an on-site detection system 100 may comprise a WAV camera 110 and a MMW camera 130. Depending on the embodiment, the WAV camera 110 and the MMW camera 130 may be collocated. In other embodiments, the WAV camera 110 may be positioned differently from the MMW camera 130, in order to take advantage of the field of view of the WAV camera 110, and the distances at which the MMW camera can operate effectively.

In embodiments, the WAV camera 110 may include a general focus mechanism 112 to focus on the camera's field of view generally. An individual focus mechanism 114 may enable focus on one or more individuals within the camera's field of view. In embodiments, such focus may include facial recognition techniques to enable identification of individuals. In an embodiment, one or more imaging sensor(s) 116 may provide an image within the WAV camera 110's field of view. Depending on the embodiment, a processing system 120 may communicate with any or all of general focus mechanism 112, individual focus mechanism 114, and imaging sensor(s) 116.

In embodiments, processing system 120 may include one or more central processing units (CPUs) and/or graphics processing units (GPUs) 122, volatile memory 124, and non-volatile storage 126. Ordinarily skilled artisans will appreciate that the referenced CPUs and GPUs may be found in a single processor which has multiple CPU cores and multiple GPU cores. In an embodiment, processing system 120 may run one or more programs which, when executed, process information from one or more of general focus mechanism 112, individual focus mechanism 114, and/or imaging sensor(s) 116 to provide one or more suitable outputs to MMW camera 130, to enable MMW camera 130 to focus appropriately on an individual and take an image from which possible concealed weapon detection may be determined.

In an embodiment, an MMW camera 130 may provide two output images. One or more RGB sensors 132 may provide one or more RGB images. One or more MMW sensors 134 may provide one or more MMW images. In embodiments, in the MMW camera 130, the RGB sensor(s) 132 and the MMW sensor(s) 134 may be synchronized through calibration at the time of manufacture. As a result, the image coordinate system of the MMW sensor(s) 134 may be the same as that of the RGB sensor(s) 132.

As will be discussed in more detail herein, in an embodiment, the MMW sensor(s) 134 may use the image(s) from RGB sensor(s) 132 to home in on an individual to enable concealed weapons detection (CWD) from a distance according to an embodiment. In embodiments, a coarse pan/tilt control 136 may initiate concentration of the MMW sensor(s) 134 on an individual within the WAV camera's field of view. A fine pan/tilt control 138 may enable focus of the MMW sensor(s) 134 on the individual.

In embodiments, the RGB sensor(s) 132, the MMW sensor(s) 134, the coarse pan/tilt control 136, and the fine pan/tilt control 138 may communicate along communications line or bus 140 with processing system 150 within MMW camera 130. In embodiments, processing system 150 may include one or more central processing units (CPUs) and/or graphics processing units (GPUs) 152, volatile memory 154, and non-volatile storage 156. Ordinarily skilled artisans will appreciate that the referenced CPUs and GPUs may be found in a single processor which has multiple CPU cores and multiple GPU cores.

In an embodiment, processing system 150 may run one or more programs which, when executed, process information from one or more of the RGB sensor(s) 132, the MMW sensor(s) 134, coarse pan/tilt control 136, and/or fine pan/tilt control 138 to provide one or more suitable images from MMW sensor(s) 134. These images in turn may be output to a concealed weapon analysis system 160, either collocated with or remotely located from MMW camera 130, for determination of possible concealed weapon detection.

In FIG. 1B, according to an embodiment, MMW camera 130 may take a passive image of an individual, using MMW radiation that the individual may output, and will communicate that image to concealed weapon analysis system 160. In an embodiment, concealed weapons analysis system 160 may be off-site. In embodiments, concealed weapons analysis system 160 may include a processing system 170 which may run one or more programs which process the image information from MMW camera 130 to determine whether the imaged individual is carrying any concealed weapons. In embodiments, processing system 170 may include one or more central processing units (CPUs) and/or graphics processing units (GPUs) 172, volatile memory 174, and non-volatile storage 176. Ordinarily skilled artisans will appreciate that the referenced CPUs and GPUs may be found in a single processor which has multiple CPU cores and multiple GPU cores.

In an embodiment, in response to a determination that an individual is carrying any concealed weapons, notification apparatus 180 within the concealed weapon analysis system 160 may notify personnel on site to detain the individual in order to search for the concealed weapons. In response to a determination that an individual is not carrying any concealed weapons, notification apparatus 180 may remain silent. Depending on the embodiment, the notification apparatus 180 may be integral with, remote from, or otherwise separate from concealed weapons detection system 180. The notification provided may take any suitable form, including but not limited to any or all of light emission, sound generation, and/or vibration generation, that will alert on-site personnel to take action in the event of concealed weapons detection.

Referring back to FIG. 1A, in an embodiment, as an alternative to a remotely located concealed weapons analysis system 160, detection system 100 may itself contain the necessary hardware and software to provide any required notifications. In an embodiment, detection system 100 may include a processing system 190 which may run one or more programs which process the image information from MMW camera 130 to determine whether the imaged individual is carrying any concealed weapons. In embodiments, processing system 190 may include one or more central processing units (CPUs) and/or graphics processing units (GPUs) 192, volatile memory 194, and non-volatile storage 196. Ordinarily skilled artisans will appreciate that the referenced CPUs and GPUs may be found in a single processor which has multiple CPU cores and multiple GPU cores.

In an embodiment, in response to a determination by detection system 100 that an individual is carrying any concealed weapons, notification apparatus 195 within the detection system 100 may notify personnel on site to detain the individual in order to search for the concealed weapons. In response to a determination that an individual is not carrying any concealed weapons, notification apparatus 195 may remain silent. Depending on the embodiment, the notification apparatus 195 may be integral with, remote from, or otherwise separate from detection system 100. The notification provided may take any suitable form, including but not limited to any or all of light emission, sound generation, and/or vibration generation, that will alert on-site personnel to take action in the event of concealed weapons detection.

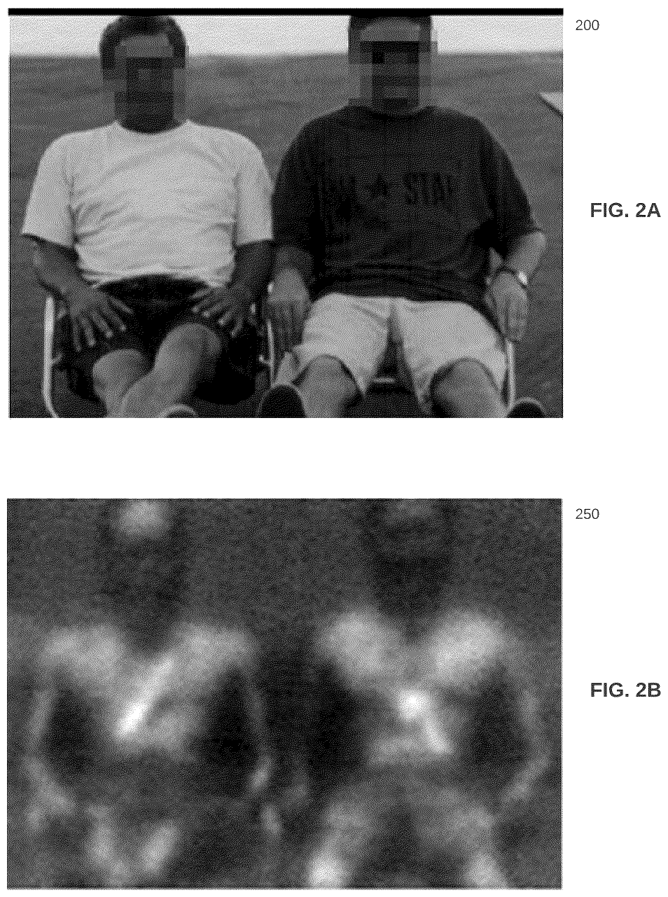

FIGS. 2A and 2B show sample output images from an MMW camera according to an embodiment. The image 200 in FIG. 2A comes from RGB sensor(s) 132. The image 250 in FIG. 2B comes from MMW sensor(s) 134. In embodiments, image 250 is the result of passive radiation from the subjects from whom the image is taken. An MMW sensor may be able to detect this passive radiation up to a distance which may vary depending on the sensor, as ordinarily skilled artisans will appreciate.

In embodiments, the MMW camera 130 may be positioned at a suitable distance at entrances to schools, shopping malls, or transportation locations (train, subway), for example, among other places. In some instances, it may make sense to have the MMW camera 130 positioned at a suitable distance from parking lots at these types of facilities, to enable earlier detection of concealed weapons and give law enforcement and/or security officials more time to respond.

In embodiments, detecting passive radiation from a subject is a desirable alternative to emitting active radiation at the subject, for various obvious health, safety, security, and privacy related reasons. Accordingly, aspects of the invention are intended to work with passive radiation sensors in MMW camera 130 to whatever distance may be technologically feasible. Among the issues that might affect effective distance of operation might be the presence or absence of obstructions in the FOV of the MMW camera 130, diminishing the ability of the concealed weapons detection system to detect concealed weapons on an individual. For example, if individuals have to pass by any trees or bushes around an entrance to a school or shopping center, the FOV of the MMW camera may be partly obstructed. The same limitation may pertain when the MMW camera is trained at a parking lot. In that instance, parked or moving cars could obstruct the FOV of the MMW camera.

In an embodiment, where there are multiple people in the FOV of the WAV camera, it is possible to prioritize detection of individuals according to one or more predetermined criteria. For example, if one individual is observed to be moving more quickly than others through the FOV of the WAV camera, processing to detect that individual might be carried out first, in order to make sure that the detection process is undertaken before the individual can get out of the FOV of the WAV camera. In an embodiment, if the individual does get out of the FOV before the appropriate scanning/detection can be done, focus can switch to another individual in the FOV. Alternatively, in embodiments in which multiple WAV and MMW camera systems are provided, if the individual comes into the FOV of a WAV camera in a next system, detection could be undertaken with that system. In an embodiment, there could be a “handoff” from the first system to the next.

In an embodiment, an individual determined to be nearest to moving out of the field of view of the WAV camera may be focused on, irrespective of how quickly the individual is moving, again for purposes of making sure that the detection process is undertaken before the individual can get out of the FOV of the WAV camera. Again, in an embodiment, if the individual does get out of the FOV before the appropriate scanning/detection can be done, focus can switch to another individual in the FOV. Alternatively, in embodiments in which multiple WAV and MMW camera systems are provided, if the individual comes into the FOV of a WAV camera in a next system, detection could be undertaken with that system. In an embodiment, there could be a “handoff” from the first system to the next.

One problem with detecting concealed weapons on an individual from a distance in an open area is that in an area where such detection is desirable, the individual will not be the only person in the area, meaning that multiple people could interfere with each other at any given time. In order to meet the demanding timelines of precise identification and analysis of whether someone is carrying a concealed weapon or explosive device, in an embodiment the concealed weapons detection system may continuously capture images of the individuals and rapidly providing the output of the MMW sensor(s) output in a precise and automated fashion.

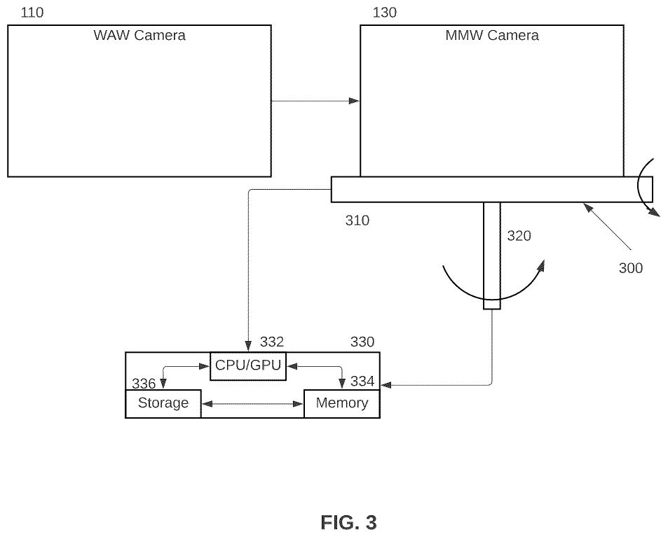

FIG. 3 is a high level diagram of a concealed weapon detection apparatus according to an embodiment. In an embodiment, as in FIG. 1A the apparatus includes a WAV camera 110 and a MMW camera 130. In an embodiment, as discussed earlier, the MMW camera may include RGB sensor(s) 132 and MMW sensor(s) 134. In an embodiment, the apparatus includes a pan-tilt apparatus 300.

In FIG. 3, the MMW camera 130 is mounted on a platform 310 of a pan-tilt apparatus 300. The WAV camera 110 monitors people in an open area while the MMW camera 130 tracks an individual in the FOV of the WAV camera 110 in order to conduct concealed weapon detection. In an embodiment, the movement of the MMW camera 130 may be guided by a multi-target tracking module, in which each person in an image from the WAV camera 110 may be detected and tracked. A position of a tracked person within image coordinates of the WAV camera 110 may be handed over to a pan-tilt control module 330. The pan-tilt control module 330 may output control signals to pan the MMW camera by rotating platform 310 about an axis centered on a rod or pole 320 on which the platform 310 is mounted. The pan-tilt control module also may output control signals, either the same signals as just discussed or different signals, to tilt the MMW camera by tilting platform 310 around an axis centered in a midpoint of platform 310 to capture that person. Depending on the embodiment, the tilt axis may run from left to right through platform 310 in FIG. 3, or may run into and out of FIG. 3 through platform 310.

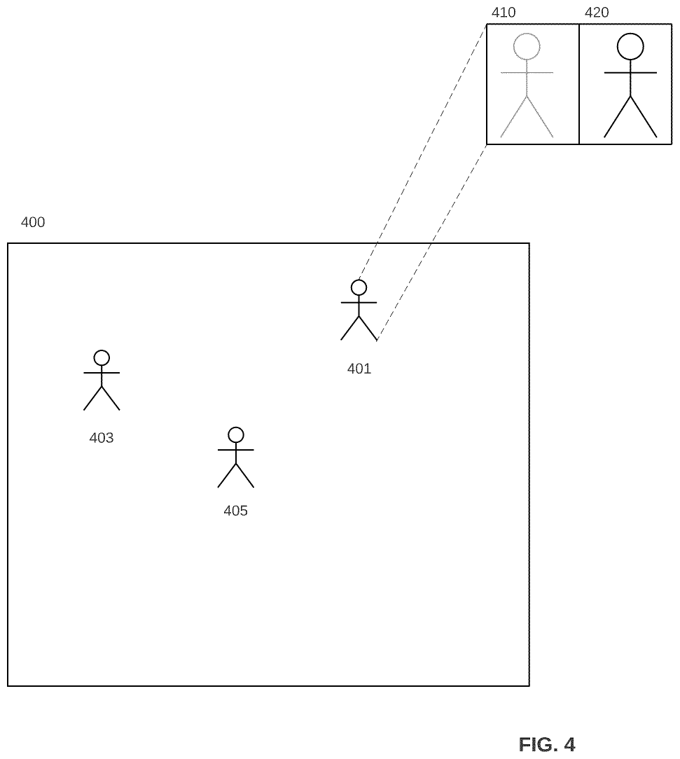

FIG. 4 depicts an FOV of WWV camera 110 with individuals 401, 403, and 405 located within the FOV. In an embodiment, MMW camera 130 will take an RGB image and an MMW image of one of the individuals, in this case individual 401. The MMW image may be transmitted to the concealed weapon detection system, which in an embodiment may run one or more algorithms, including but not limited to image processing algorithms, to enable concealed weapon detection and analysis.

In an embodiment, once analysis is complete for individual 401, the process may be repeated for individual 403 and/or individual 405 if they are still in the WAV camera's FOV. Depending on the embodiment, if none of these individuals is still in the WAV camera's FOV, the WAV camera may identify other individuals in the FOV, and determine an appropriate order of these individuals for concealed weapons detection and analysis. In an embodiment, individuals coming into the WAV camera's FOV while initially-identified individuals are still in the FOV may be examined, for example, to determine how quickly they are moving. If one of the newly-appearing individuals is moving more quickly than the other individuals in the FOV, a determination may be made that the most quickly moving individual should be analyzed first.

One of the problems to be solved in the course of implementing embodiments of the present invention relates to determining how an x-y position in the image coordinate system of the WAV camera can map to the pan and tilt angles of the pan-tilt apparatus to move the MMW camera. In an embodiment, the following two-step calibration procedure may be employed. The first step is a coarse calibration, to ensure that an image of an individual in the WAV camera can be captured by the MMW camera. The second step is a fine calibration, providing a fine adjustment of the field of view so that the person captured by the MMW camera will have their position in the camera for the MMW sensor(s) adjusted finely to the center of the camera. This centering is part of what enables a determination of whether the person is carrying concealed weapons.

The first, coarse calibration may be performed either manually or automatically. If course calibration is performed automatically, pan angles for the MMW camera may be set to be [P₀, P₁, . . . , Pₙ] in a very fine granularity to make sure not only that the pan angles from P₀ to Pₙ cover the entire horizontal field of view of the WAV camera, but also that the images that the RGB sensor of the MMW camera generates at Pᵢ₋₁ and Pᵢ have a large degree of overlap. The degree of overlap is desirable in order to ensure that all parts of the FOV are examined. In similar fashion, tilt angles may be set to be [T₀, T₁, . . . , Tₙ] in a very fine granularity to make sure not only that the tilt angles from T₀ to Tₙ cover the entire vertical view of the WAV camera, but also that the images that the RGB sensor generates at Tᵢ₋₁ and Tᵢ have a large degree of overlap. Again, the degree of overlap is desirable in order to ensure that all parts of the FOV are examined.

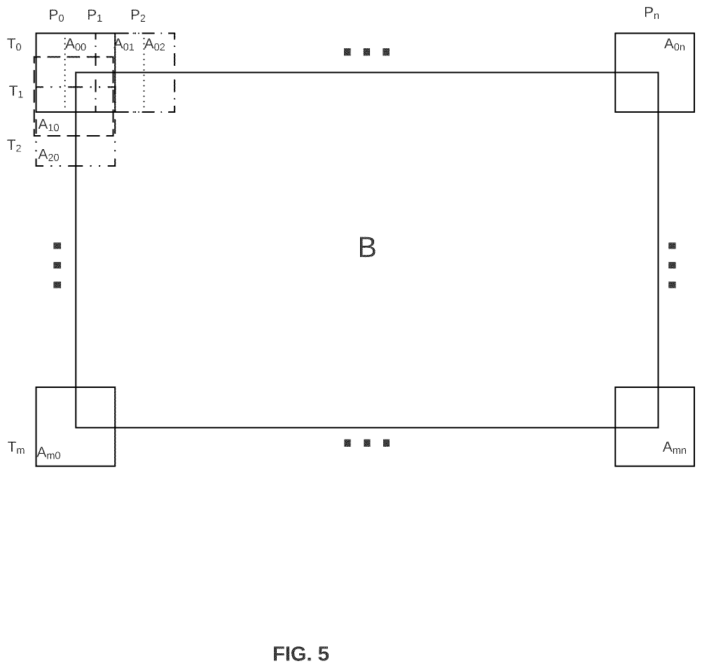

FIG. 5 illustrates the foregoing procedure, where B is the image from the WAV camera and Aᵢⱼ is an image taken by the RGB sensor of the MMW camera at Pᵢ and Tⱼ. In FIG. 5, images A₀₀, A₀₁, A₀₂, . . . , and A₀ₙ, are shown at pan positions P₀, P₁, P₂, . . . , and Pₙ, respectively. Images A₀₀, A₀₁, and A₀₂ overlap each other in the pan direction. Images A₀₀, A₁₀, A₂₀, . . . , Aₘ₀ are shown at tilt positions T₀, T₁, T₂, . . . , Tₘ, respectively. Images A₀₀, A₁₀, and A₂₀ overlap each other in the tilt direction. In a number of instances, along the respective pan and tilt axes, images along the pan direction will overlap with images in the tilt direction, with the degree of overlap being sufficient to ensure that all parts of the FOV are covered. For example, FIG. 5 shows images A₀₁ and A₁₀ overlapping each other.

Using the above procedure, ordinarily skilled artisans will appreciate that a sequence of images [A₀₀ . . . . A₀ₙ] that the RGB sensor of the MMW camera generates at T₀ and P₀, P₁, P₂, . . . , and Pₙ may overlap with a respective sequence of images [A₁₀ . . . . Ain] that the RGB sensor of the MMW camera generates at T₁ and P₀, P₁, P₂, . . . , and Pₙ. Respective images that the RGB sensor of the MMW camera generates at T₁ and P₀, P₁, P₂, . . . , and Pₙ also may overlap with a respective sequence of images [A₂₀ . . . . A₂ₙ] that the RGB sensor of the MMW camera generates at T₂ and P₀, P₁, P₂, . . . , and Pₙ. Following this pattern, ordinarily skilled artisans will appreciate that, other than the images at rows 0 and m in the tilt direction and columns 0 and n in the pan direction, all intervening rows and columns of RGB images will overlap with their respective neighbors.

In addition to the overlapping just discussed, FIG. 5 shows how images along the pan and tilt directions along the periphery of the image from the WAV camera overlap the images from the WAV camera. Taking all of the foregoing into account, the following matrix of images may be obtained:

$$( \begin{matrix}{A}_{00} & … & {A}_{0 n} \\ ⋮ & ⋱ & ⋮ \\ {A}_{0 m} & … & {A}_{mn}\end{matrix} ) ,$$

where each image Aᵢⱼ (other than i=0 or m in the tilt direction and j=0 or n in the pan direction) overlaps the images A_{i-1,j}, A_{i-1,j-1} A_{i+1,j}, A_{i+1,j+1}, and also overlaps the image B from the WAV camera.

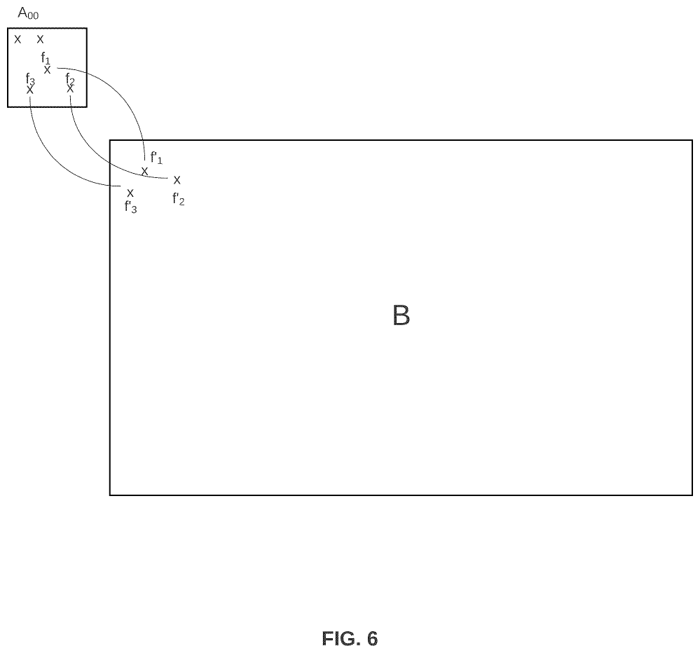

In FIG. 6, image A_{0,0} is an image taken by the MMW camera at pan P₀ and tilt T₀, respectively. B is an image from the WAV camera. In an embodiment, a scale invariant feature transform may aid in detecting and matching image feature points within the image A_{0,0}. Based on feature points f₀, . . . , fₙ from image A_{0,0} and feature points f′₀, . . . , f′ₙ from image B, a homograph matrix transform between the two images may be calculated using the following equation:

$$[ {X}_{A} , {Y}_{A} ] = {H}_{AB} ( \begin{matrix}{X}_{B} \\ {Y}_{B} \\ 1\end{matrix} ) ,$$

where X_{A}, Y_{A} are the x and y coordinates of the feature points in image A₀₀; X_{B}, Y_{B} are the x and y coordinates of the feature points in image B; and H_{AB} is a homograph transforming one image to another.

With the homograph H_{AB}, it is possible to map the center of A₀₀, i.e., (X_{C}^{A}, Y_{C}^{A}), to the image B, i.e., (X_{C}^{B}, Y_{X}^{B}) at a pan angle P₀ and a tilt angle T₀. Likewise, it is possible to obtain a list of pan and tilt angles and their corresponding mapping values to the image B of the WAV camera. This approach yields a number of entries as shown in the following Table 1, in which a number of entries is the same as the number of components in the matrix of images above, in this case n×m.

TABLE 1

| Pan | Tilt | Mapping value on the image B |
|---|---|---|
| P₀ | T₀ | (x_{c}, y_{c})₀₀ |
| P₀ | T₁ | (x_{c}, y_{c})₀₁ |
| . . . | . . . | . . . |
| Pᵢ | Tⱼ | (x_{c}, y_{c})ᵢⱼ |
| . . . | . . . | . . . |
| Pₘ | Tₙ | (x_{c}, y_{c})ₘₙ |

Using the values in Table 1, in an embodiment polynomial regression may be used to establish expected values of pan and tilt for the movement of the MMW camera to the x-y position in the image coordinate system of the WAV camera per equations (1) and (2) below:

$$P = {a}_{n} {X}^{n} + {a}_{n - 1} {X}^{n - 1} + … + {a}_{0} \qquad ( 1 )$$

$$T = {b}_{n} {Y}^{n} + {b}_{n - 1} {Y}^{n - 1} + … + {b}_{0} \qquad ( 2 )$$

where n is the degree of the polynomial, and [aₙ, aₙ₋₁, . . . , a₀] and [bₙ, bₙ₋₁, . . . , b₀] are the coefficients of the polynomial to solve. In an embodiment, with 2≤n≤5 may provide a sufficient degree to map the x-y position with sufficient accuracy.

With the mapping data in the table, in an embodiment a form of least squares analysis may be used to solve for the coefficients. Once the polynomial coefficients are determined, the relationship between the movement (P, T) of the MMW camera and the position (x, y) of the detected person in the wide-angle-view camera may be established using Equations (1) and (2). With this relationship, given a position (x, y) of the detected person in the WAV camera, the expected value of pan and tilt to move the MMW camera to capture that person for concealed weapon detection can be obtained.

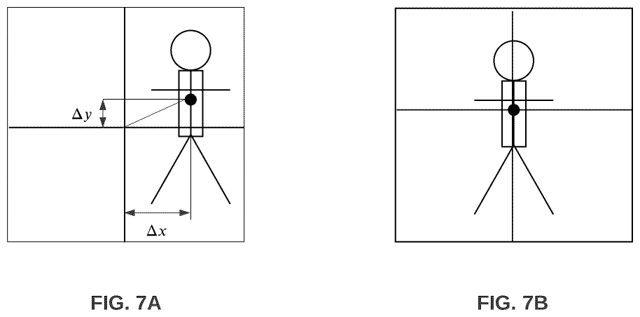

In general, a person that the MMW camera captures through the above procedure may not necessarily be in the image center of the MMW sensor, as FIG. 7A illustrates. In some embodiments, the relatively narrow field of view (FOV) of the MMW sensor may mean that, for most effective scanning, the person to be in the center of camera. In order to move the MMW camera to the center of the detected person, fine calibration is needed within the MMW camera. This step of calibration can be done indoors.

FIG. 7B shows that in order to let the MMW camera target the center of the human body in FIG. 7A, the MMW camera 130 needs to move up by Δy and move to the right by Δx. Consequently, it is necessary to create a mapping relationship between the movement of the MMW camera (ΔP, ΔT) and the displacement (Δx, Δy). In an embodiment, such a step would be a fine calibration within the MMW camera.

In an embodiment, centering of the individual within the FOV of the MMW camera need not be perfect, but the person should be sufficiently inside the edges of the field of view of the MMW camera for proper analysis and detection to take place. As a practical matter, the person's positioning inside that field of view can vary as the person moves, so the more centered the person can be in the field of view of the MMW camera, the better, in general. In an embodiment, the movement of the MMW camera might be adjusted to accommodate different speeds at which a person might move within the area of interest.

For example, if the person might slow down, as for example when there is a crowd or line of people ahead, the person might better be positioned farther ahead in the field of view of the MMW camera so that when the person slows down, the MMW camera can lag the person's deceleration a bit, and the person can be more centered in the field of view of the MMW camera after the slowdown. If the person might speed up, as for example after passing through a crowd or line of people ahead, the person might better be positioned farther back in the field of view of the MMW camera so that when the person speeds up, the MMW camera can lag the person's acceleration a bit, and the person can be more centered in the field of view of the MMW camera after the speed up.

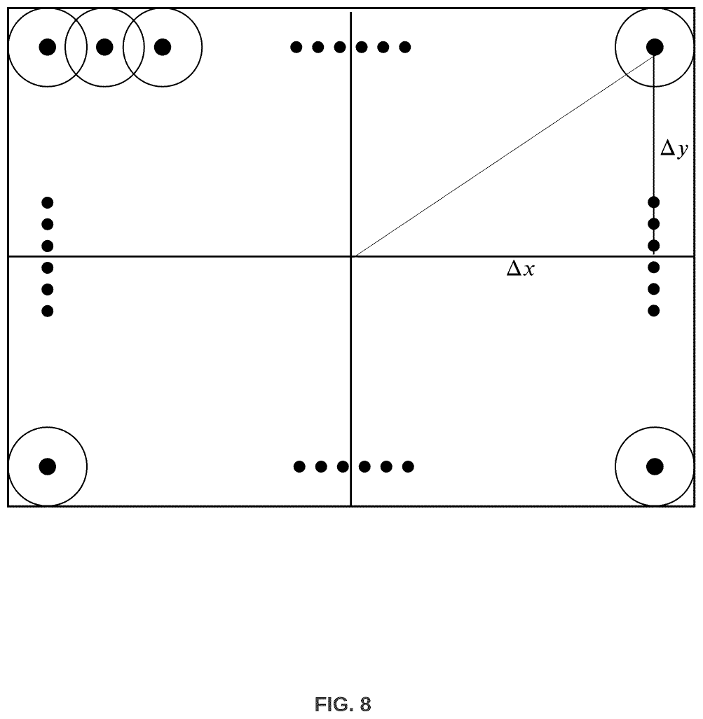

In an embodiment, to perform the fine calibration, first, a target board as shown in FIG. 8 may be created, wherein the location of each target center relative to the center of the image (Δx, Δy) is known beforehand. Second, ΔP and ΔT can be adjusted manually to move the MMW camera so that the image center is the target center. This can be done for each target center, resulting in a data set describing correspondence between (ΔP, ΔT) and (Δx, Δy). Again, polynomial regression can be used to establish the mapping relationship between (ΔP, ΔT) and (Δx, Δy) by using the following equations.

$$Δ P = {a}_{n} Δ {x}^{n} + {a}_{n - 1} Δ {x}^{n - 1} + … + {a}_{0} \qquad ( 3 )$$

$$Δ T = {b}_{n} Δ {y}^{n} + {b}_{n - 1} Δ {y}^{n - 1} + … + {b}_{0} \qquad ( 4 )$$

Using least squares analysis, it is possible to solve for the polynomial coefficients [aₙ, aₙ₋₁, . . . , a₀] and [bₙ, bₙ₋₁, . . . , b₀] for Equations 3 and 4, respectively. Once the polynomial coefficients are determined, the mapping relationship between (ΔP, ΔT) and (Δx, Δy) may be established. Given (Δx, Δy), the displacement of the human body from the image center of the MMW camera, it is possible to determine how much pan (ΔP) and tilt (ΔT) would be required to center the MMW sensor of the MMW camera on the center of the human body to be examined in order to detect whether there are any concealed weapons.

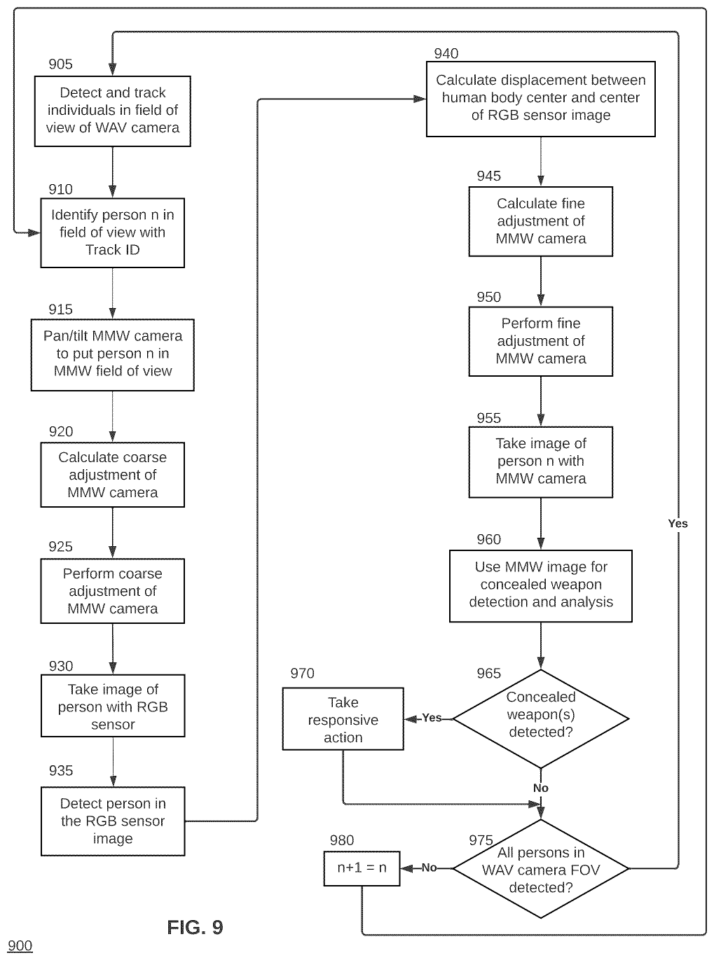

In an embodiment, FIG. 9 depicts a flow of operation of the concealed weapon detection system after the above two-step calibration. At 905, the system will detect and track individuals in the field of view of the WAV camera. At 910, an individual is identified for tracking purposes, and is given a Track ID. As discussed previously, depending on the embodiment, different criteria may be employed to identify the individual. In an embodiment, the Track ID may be associated with the (x,y) position of the individual, where (x,y) is an image coordinate of the wide-angle-view camera.

At 915, using the individual's (x, y) position, the MMW camera may be panned and tilted to place the individual in the field of view of the MMW camera. At 920, a coarse pan and tilt (P, T) for the movement of the MMW camera may be calculated. At 925, using the calculation in 920, a coarse centering of the individual within the field of view of the MMW camera may be performed.

At 930, the MMW camera may take an image of the individual with the RGB sensor. At 935, the person in the RGB sensor image is detected. At 940, a distance in (Δx, Δy) between the center of the RGB sensor and the center of the individual's body is calculated. In this regard, it should be borne in mind that, in an embodiment, the MMW sensor and the RGB sensor in the MMW camera will have been calibrated, as noted earlier, so that the (Δx, Δy) displacement with the RGB sensor will translate appropriately for the MMW sensor.

At 945, fine adjustment to pan and tilt of the MMW camera ((ΔP, ΔT)) is calculated. At 950, the MMW camera may be moved by (ΔP, ΔT) so that the image center of the MMW sensor aligns with the center of the individual's body. At 955, the MMW camera takes an MMW image of the individual. At 960, the MMW image is used to determine whether the individual has any concealed weapons. As discussed previously, the determination may be made at the MMW camera itself, or in a locally-placed concealed weapon detection system, or in a remotely-located concealed weapon detection system.

At 965, the determination of concealed weapon presence is made. If concealed weapons are detected, then at 970 responsive action is taken. Appropriate notification may be provided to security guards and/or law enforcement personnel, and the individual may be intercepted and/or detained. At 975, in an embodiment, after either detection of concealed weapons or determination that there are no concealed weapons, a determination may be made whether there are any other individuals in the WAV camera FOV to be identified. In an embodiment, the determination at 975 need not await action on the individual with the concealed weapons. Since security guards and/or law enforcement officials will be dispatched, the outcome of the interception of the individual need not delay detection of additional individuals. As noted previously, depending on the embodiment and/or the circumstance, while an individual within the WAV camera FOV is being scanned to determine whether there are any concealed weapons, other individuals may pass in or out of the WAV camera FOV, necessitating a return to 905 to perform further detection and tracking. In an embodiment, if there are individuals who previously were in the WAV camera FOV who have not yet been scanned (for example, someone else who had been assigned a Track ID), that person may be the next one scanned. In that event, at 980 the number n is incremented by one, and flow returns to 910 to identify the person with that Track ID.

In an embodiment, as noted previously, the concealed weapons detection system may have multiple WAV cameras and multiple associated MMW cameras to cover adjacent and/or overlapping areas. If someone with a particular Track ID passes out of the FOV of one WAV camera and into another, the Track ID from the prior system can be passed along to the current system, and the individual with that Track ID can go into a queue for that current system to be detected and analyzed.

While embodiments of the invention have been described in detail above, ordinarily skilled artisans will appreciate that various modifications within the scope and spirit of the invention are possible. In particular, the identification of certain variants in the course of this description is by no means intended to be an exhaustive list. Rather, identification of those variants provides examples to inform ordinarily skilled artisans about the types of variants that are contemplated here. Accordingly, the scope of the invention is to be construed as limited only by the scope of the following claims.

What is claimed is:

1. A system comprising:
a wide angle view (WAV) camera with a WAV field of view (FOV);
a millimeter wave (MMW) camera, the MMW camera having an MMW FOV and comprising an RGB sensor to take RGB images, and an MMW sensor to take MMW images, wherein the RGB sensor and the MMW sensor are aligned with each other to coordinate an FOV of the RGB sensor and an FOV of the MMW sensor;
apparatus to align the WAV camera and the MMW camera so that the MMW FOV moves within the WAV camera FOV;
a processor and a memory, the memory containing a program with instructions which, when executed by the processor, cause the processor to perform the following:
a) identifying a first individual in the WAV camera FOV;
b) panning and/or tilting the MMW camera to provide a coarse adjustment to center the first individual in the MMW sensor FOV;
c) taking an RGB image of the first individual with the MMW camera;
d) responsive to a position of the first individual in the RGB image, further panning and/or tilting the MMW camera to provide a fine adjustment to center the first individual in the MMW sensor FOV;
e) taking an MMW image of the first individual with the MMW camera;
f) analyzing the MMW image to determine whether the first individual has any concealed weapons on their person.

2. A system as claimed in claim 1, wherein the memory contains further instructions to cause the processor to perform, responsive to a determination that the first individual has concealed weapons on their person, signaling a need for corrective action to detain and/or apprehend the individual.

3. A system as claimed in claim 1, wherein the apparatus comprises apparatus to perform the coarse adjustment of the MMW camera, and the fine adjustment of the MMW camera.

4. A system as claimed in claim 1, wherein the processor and memory are local to the MMW camera.

5. A system as claimed in claim 1, wherein the WAV camera and the MMW camera are colocated.

6. A system as claimed in claim 1, wherein the program contains further instructions to cause the processor to perform the following:
responsive to detection of a plurality of individuals in the WAV camera FOV, tracking the plurality of individuals; and
selecting a first one of the plurality of individuals and performing b) to f) on the selected first one of the plurality of individuals.

7. A system as claimed in claim 6, wherein the program contains further instructions to cause the processor to perform the following:
responsive to performing b) to f) on the selected first one of the plurality of individuals, selecting a second one of the plurality of individuals and performing b) to f) on the selected second one of the plurality of individuals.

8. A system as claimed in claim 6, wherein the program contains further instructions to cause the processor to perform the following:
assigning a track identifier (ID) to each of the plurality of individuals, and selecting each of the plurality of individuals on whom to perform b) to f) according to respective track IDs.

9. A system as claimed in claim 6, wherein the program contains further instructions to cause the processor to perform the following:
selecting the first one of the plurality of individuals according to a speed with which the individual is moving through the WAV camera FOV.

10. A system as claimed in claim 1, comprising first and second WAV cameras and MMV cameras, each WAV camera having a different field of view, wherein the program contains further instructions to cause the processor to perform the following:
responsive to the first individual moving out of the first WAV camera FOV, detecting the first individual with another of the plurality of WAV cameras; and
performing b) to f) with the second WAV camera.

11. A method comprising:
a) identifying a first individual in a field of view (FOV) of a wide angle view (WAV) camera; wherein the WAV camera and MMW camera are aligned so that the MMW FOV moves within the WAV camera FOV, wherein the MMW camera has an RGB sensor and an MMW sensor which are aligned to coordinate an FOV of the RGB sensor and an FOV of the MMW sensor;
b) panning and/or tilting the MMW camera to provide a coarse adjustment to center the first individual in the MMW sensor FOV;
c) taking an RGB image of the first individual with the MMW camera;
d) responsive to a position of the first individual in the RGB image, further panning and/or tilting the MMW camera to provide a fine adjustment to center the first individual in the MMW sensor FOV;
e) taking an MMW image of the first individual with the MMW camera; and
f) analyzing the MMW image to determine whether the first individual has any concealed weapons on their person.

12. A method as claimed in claim 11, further comprising, responsive to a determination that the first individual has concealed weapons on their person, signaling a need for corrective action to detain and/or apprehend the individual.

13. A method as claimed in claim 11, further comprising, before b), panning and/or tilting the MMW camera to place the first individual in the MMW camera FOV;

14. A method as claimed in claim 11, further comprising collocating the WAV camera and the MMW camera.

15. A method as claimed in claim 11, further comprising:
responsive to detection of a plurality of individuals in the WAV camera FOV, tracking the plurality of individuals; and
selecting a first one of the plurality of individuals and performing b) to f) on the selected first one of the plurality of individuals.

16. A method as claimed in claim 15, further comprising:
responsive to performing b) to f) on the selected first one of the plurality of individuals, selecting a second one of the plurality of individuals and performing b) to f) on the selected second one of the plurality of individuals.

17. A method as claimed in claim 15, further comprising:
assigning a track identifier (ID) to each of the plurality of individuals, and selecting each of the plurality of individuals on whom to perform b) to f) according to respective track IDs.

18. A method as claimed in claim 15, further comprising:
selecting the first one of the plurality of individuals according to a speed with which the individual is moving through the WAV camera FOV.

19. A method as claimed in claim 13, further comprising:
calculating a displacement between a center of the first individual and a center of the RGB image; and
performing d) after the calculating.

20. A method as claimed in claim 11,
responsive to the first individual moving out of the WAV camera FOV, detecting the first individual with a second WAV camera; and
performing b) to f) with the second WAV camera.
